(19) United States
(12) Patent Application Publication
(10) Pub. No.: US 2026/0152925 A1
(43) Pub. Date: Jun. 4, 2026

(54) Hydraulic System, Work Vehicle, Control Method, and Computer Program

(71) Applicant: Kubota Corporation, Osaka-shi (JP)

(72) Inventor: Yasuhiro Manji, Sakai-shi (JP)

(21) Appl. No.: 19/402,308

(22) Filed: Nov. 26, 2025

(30) Foreign Application Priority Data
Dec. 2, 2024 (JP) 2024-209452

(51) Int. Cl. E02F 9/22; E02F 9/20; F15B 13/02; F15B 13/044; F15B 15/18

(52) U.S. Cl. CPC E02F 9/2203; E02F 9/2004; F15B 13/024; F15B 13/044; F15B 15/18

(57) ABSTRACT

A technique capable of obtaining an output higher than a normal output as necessary is provided. A hydraulic system S includes a hydraulic pump 32, a supply oil passage 58 that supplies hydraulic oil from the hydraulic pump 32 to a front loader 4 operated by hydraulic pressure, a pump motor 30 that drives the hydraulic pump 32, and a processing device 18 that performs selection processing of selecting a control mode of the pump motor 30 from a first mode and a second mode. The first mode is a mode in which an upper limit value of a torque command value indicating torque to be output by the pump motor 30 is a first command value. The second mode is a mode in which the upper limit value is a second command value larger than the first command value.

### CROSS-REFERENCE TO RELATED APPLICATION

This application claims priority to Japanese Patent Application No. 2024-209452 filed Dec. 2, 2024, the disclosure of which is hereby incorporated by reference in its entirety.

### BACKGROUND OF THE INVENTION

### Field of the Invention

The present disclosure relates to a hydraulic system, a work vehicle, a control method, and a computer program.

### Description of Related Art

Japanese Laid-Open Patent Publication No. 2024-96596 discloses a work vehicle. The work vehicle includes a working device that moves up and down by hydraulic pressure. A hydraulic system that operates the working device includes a hydraulic cylinder and a hydraulic pump that generates hydraulic pressure supplied to the hydraulic cylinder. This hydraulic pump is driven by an electric motor (see, for example, Japanese Laid-Open Patent Publication No. 2024-96596).

In the above hydraulic system, a load from the outside acts on the hydraulic cylinder in accordance with the operation of the working device, and a sudden fluctuation in hydraulic pressure may occur.

Thus, a relief valve that prevents the hydraulic pressure from rising beyond a predetermined upper limit value may be provided.

The upper limit of output of the working device is determined by an upper limit value of the hydraulic pressure. Therefore, the upper limit of output of the working device is determined by a valve opening pressure of the relief valve, which is the upper limit value of the hydraulic pressure.

Meanwhile, at the time of work by the working device, an output larger than the current output may be required depending on the work content.

However, in the hydraulic system including the relief valve described above, the hydraulic pressure does not rise to the pressure at which the relief valve opens or more, and it is not possible to obtain an output larger than the current output.

### SUMMARY OF THE INVENTION

Therefore, an object of the present disclosure is to provide a technique capable of obtaining an output higher than a normal output as necessary.

A hydraulic system according to the present disclosure includes a hydraulic pump, a supply oil passage that supplies hydraulic oil from the hydraulic pump to a working device operated by hydraulic pressure, an electric motor that drives the hydraulic pump, and a processing device that performs selection processing of selecting a control mode of the electric motor from a first mode and a second mode. The first mode is a mode in which an upper limit value of a torque command value indicating torque to be output by the electric motor is a first command value. The second mode is a mode in which the upper limit value is a second command value larger than the first command value.

According to the present disclosure, output higher than normal output can be obtained as necessary.

### BRIEF DESCRIPTION OF THE DRAWINGS

FIG. 1 is a side view of a work vehicle according to an embodiment.

FIG. 2 is a block diagram illustrating an example of a power system of a work vehicle.

FIG. 3 is a block diagram illustrating an example of a hydraulic system of the work vehicle according to the first embodiment.

FIG. 4 is a flowchart illustrating an example of selection processing performed by a processing device.

FIG. 5 is a block diagram illustrating a part of a hydraulic system according to a second embodiment.

### DESCRIPTION OF THE INVENTION

First, contents of the embodiments will be listed and described.

### Outline of Embodiments

(1) A hydraulic system according to the present disclosure includes a hydraulic pump, a supply oil passage that supplies hydraulic oil from the hydraulic pump to a working device operated by hydraulic pressure, an electric motor that drives the hydraulic pump, and a processing device that performs selection processing of selecting a control mode of the electric motor from a first mode and a second mode. The first mode is a mode in which an upper limit value of a torque command value indicating torque to be output by the electric motor is a first command value. The second mode is a mode in which the upper limit value is a second command value larger than the first command value.

With the above configuration, since the control mode of the electric motor can be selected from the first mode and the second mode in which the upper limit value of the torque command value to the electric motor is different from each other, it is possible to select the first mode in which the upper limit value of the torque command value is low at a normal time and select the second mode in which the upper limit value of the torque command value is higher when higher output is required in the working device. Thus, for example, if the second command value is increased to an allowable extent in the case of use for a short time, an output higher than a normal output can be obtained from the working device as necessary.
(2) When the hydraulic system of (1) further includes an operation switch capable of receiving an operation input of an operator, the selection processing may be configured to select the control mode on the basis of an output of the operation switch.

In this case, the operator can select the control mode as necessary.
(3) When the hydraulic system of (1) or (2) further includes a relief valve that opens when a hydraulic pressure of the supply oil passage reaches a predetermined valve opening pressure, a first hydraulic pressure value generated in the supply oil passage by the hydraulic pump driven by the electric motor operating with the first command value may be smaller than the valve opening pressure.

In this case, in the first mode, the electric motor can be operated in a range in which the relief valve is not opened.
(4) In the hydraulic system of (3), a second hydraulic pressure value generated in the supply oil passage by the hydraulic pump driven by the electric motor operating with the second command value may be equal to or higher than the valve opening pressure.

In this case, in the first mode, the electric motor can be operated in a range in which the relief valve opens.
(5) In the hydraulic system of (1) or (2), when the hydraulic system further includes a first relief valve that opens when a hydraulic pressure of the supply oil passage reaches the first valve opening pressure, an electromagnetic valve that opens and closes a connection oil passage connecting the first relief valve and the supply oil passage, and a second relief valve that opens when a hydraulic pressure of the supply oil passage reaches a second valve opening pressure higher than the first valve opening pressure, the first valve opening pressure is a hydraulic pressure value generated in the supply oil passage by the hydraulic pump driven by the electric motor operating with the first command value, and the second valve opening pressure is a hydraulic pressure value generated in the supply oil passage by the hydraulic pump driven by the electric motor operating with the second command value. In addition, the selection processing may include processing of opening and closing the electromagnetic valve.

In this case, two modes can be set by two relief valves.
(6) In the hydraulic system according to any one of (1) to (5), the processing device may perform processing of selecting the control mode again when the second mode is executed for a predetermined period or more.

In this case, the second mode in which the upper limit value of the hydraulic pressure is high can be used as a temporary mode. Thus, in the second mode, the hydraulic pressure can be increased to an allowable extent in the case of use for a short time, and a higher output can be obtained from the working device.
(7) From another point of view, the present disclosure is a work vehicle. The work vehicle includes a working device and the hydraulic system according to any one of (1) to (6).
(8) Further, the present disclosure viewed from another viewpoint is a control method for an electric motor that drives a hydraulic pump for supplying hydraulic oil to a working device. The control method includes selecting a control mode of the electric motor from a first mode and a second mode. The first mode is a mode in which an upper limit value of a torque command value indicating torque to be output by the electric motor is a first command value. The second mode is a mode in which the upper limit value is a second command value larger than the first command value.
(9) Furthermore, the present disclosure viewed from another viewpoint is a computer program. This computer program is a computer program for causing a computer to execute control of an electric motor that drives a hydraulic pump for supplying hydraulic oil to a working device. This computer program is a computer program that causes a computer to execute selection processing of selecting a control mode of the electric motor from a first mode and a second mode. The first mode is a mode in which an upper limit value of a torque command value indicating torque to be output by the electric motor is a first command value. The second mode is a mode in which the upper limit value is a second command value larger than the first command value.

### Details of Embodiment

Hereinafter, a preferred embodiment will be described with reference to the drawings.

Note that at least some of the embodiments described below may be arbitrarily combined.

### Overall Configuration of Work Vehicle

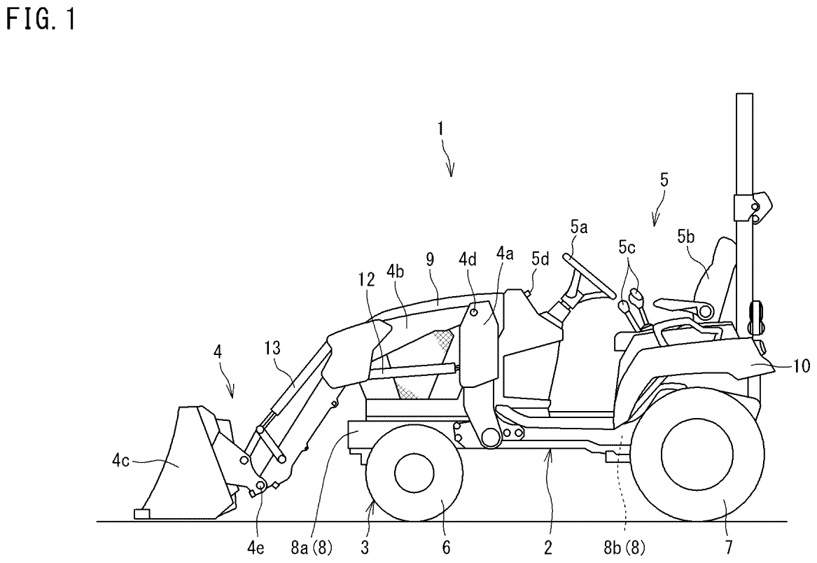

FIG. 1 is a side view of a work vehicle according to an embodiment.

The work vehicle 1 is a vehicle used for farmwork, specifically, a tractor. However, the work vehicle 1 is not limited to the tractor, and may be a mobile object such as an agricultural machine, a construction machine, or a utility vehicle.

As illustrated in FIG. 1, the work vehicle 1 includes a vehicle body 2, a traveling mechanism 3, a front loader 4, a driving unit 5, and the like.

The traveling mechanism 3 includes a pair of left and right front wheels 6 and a pair of left and right rear wheels 7. The front and rear wheels 6 and 7 are rotatably provided on an axle provided on the vehicle body 2. The traveling mechanism 3 has a function of transmitting driving force from a traveling motor 24 described later to the front and rear wheels 6 and 7 to rotationally drive the front and rear wheels 6 and 7. Thus, the traveling mechanism 3 includes a transmission mechanism (not illustrated) that transmits the driving force to the front and rear wheels 6 and 7 in addition to the front and rear wheels 6 and 7. The transmission mechanism includes rotating shafts such as a drive shaft and a propeller shaft, a differential device, a transmission device, and the like.

The vehicle body 2 includes a chassis 8, a hood 9, a fender 10, and the like. The chassis 8 includes a frame 8a and a transmission case 8b. The frame 8a and the transmission case 8b are connected to each other. The front wheels 6 are provided on the frame 8a, and the rear wheels 7 are provided on the transmission case 8b. Each unit of the work vehicle 1 such as the traveling mechanism 3, the driving unit 5, and the front loader 4 is mounted on the chassis 8.

The hood 9 is provided at a front portion of the vehicle body 2. The fender 10 is provided above the rear wheels 7.

The driving unit 5 is provided at a rear portion of the vehicle body 2. The driving unit 5 includes a steering wheel 5a, a driver's seat 5b, an operation lever 5c, an operation switch 5d, and the like. The driver's seat 5b is a seat on which a worker who drives the work vehicle 1 sits. The steering wheel 5a is a steering wheel for steering the front wheels 6. The operation lever 5c includes a lever for adjusting the speed of the work vehicle 1, an operation lever of the front loader 4, and the like.

The operation switch 5d is a switch for selecting a control mode of an upper limit value of a hydraulic system (described later). The operation lever 5c and the operation switch 5d have a function of receiving an operation input of an operator. The operation lever 5c and the operation switch 5d provide an output corresponding to the received operation input to the operation control unit 16 (described later).

The operation switch 5d is, for example, a push button switch. The operation switch 5d provides an output indicating an on state to the operation control unit 16 when pressed by the worker. The operation switch 5d provides an output indicating an off state to the operation control unit 16 when no pressing operation is performed by the worker.

The front loader 4 is a working device provided at a front portion of the vehicle body 2. The front loader 4 includes a pair of left and right frames 4a, a pair of left and right arms 4b, a bucket 4c, a pair of left and right arm cylinders 12, a pair of left and right bucket cylinders 13, and the like.

The frame 4a is provided on the left and right sides of the hood 9. The frame 4a is fixed to the frame 8a.

The arm 4b connects the frame 4a and the bucket 4c. The rear end of the arm 4b and the frame 4a are connected to each other by a shaft 4d. The axial direction of the shaft 4d is along a left-right direction. The arm 4b is swingable about the shaft portion 4d.

The front end of the arm 4b and the bucket 4c are connected to each other by a shaft 4e. The axial direction of the shaft 4e is along the left-right direction. The bucket 4c is swingable around the shaft 4e.

The pair of arm cylinders 12 is connected to the pair of frames 4a and the pair of arms 4b. When the arm cylinder 12 expands and contracts, the arm 4b swings in the vertical direction around the shaft portion 4d.

The pair of bucket cylinders 13 is connected to the pair of arms 4b and the bucket 4c. When the bucket cylinder 13 expands and contracts, the bucket 4c swings around the shaft 4e.

The pair of arm cylinders 12 and the pair of bucket cylinders 13 expand and contract in accordance with the operation of the operation lever 5c.

### Power System of Work Vehicle

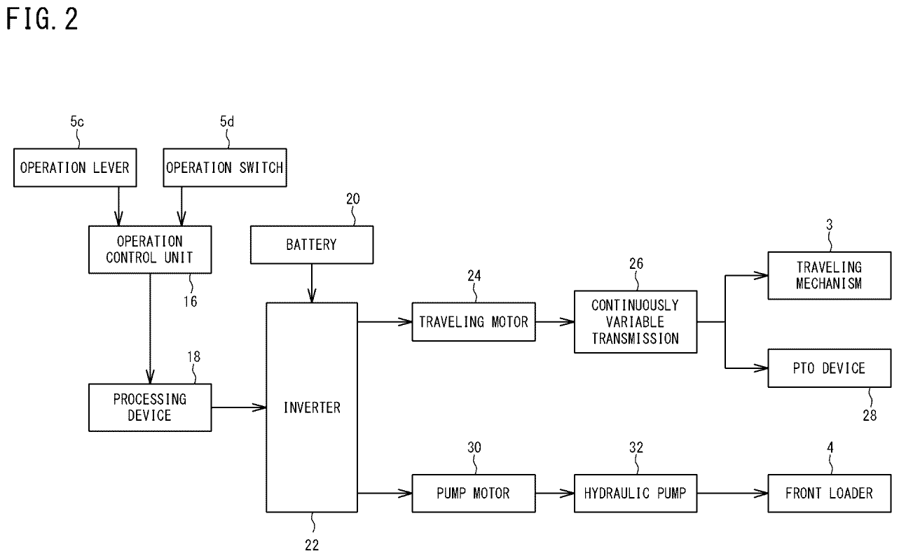

FIG. 2 is a block diagram illustrating an example of a power system of the work vehicle 1.

As illustrated in FIG. 2, the work vehicle 1 further includes an operation control unit 16, a processing device 18, a battery 20, an inverter 22, a traveling motor 24, a continuously variable transmission 26, a PTO device 28, a pump motor 30, a hydraulic pump 32, and the like.

The work vehicle 1 of the present embodiment is configured to generate hydraulic pressure by the driving force of the traveling motor 24 and the pump motor 30, and operate the traveling mechanism 3 and the front loader 4 by the hydraulic pressure.

The traveling motor 24 and the pump motor 30 are electric motors, and output rotational force by electric power stored in the battery 20.

The driving force by the traveling motor 24 is transmitted to the continuously variable transmission 26. The continuously variable transmission 26 is a hydrostatic continuously variable transmission. The continuously variable transmission 26 can continuously change the driving force from the traveling motor 24. The continuously variable transmission 26 can be operated by a worker.

The continuously variable transmission 26 varies the driving force from the traveling motor 24, and transmits the varied driving force to the traveling mechanism 3 and the PTO device 28.

The traveling mechanism 3 drives the front and rear wheels 6 and 7 by the driving force transmitted from the continuously variable transmission 26.

The PTO device 28 outputs the driving force transmitted from the continuously variable transmission 26 to, for example, a working device attached to the work vehicle 1. A clutch that interrupts the driving force is provided between the continuously variable transmission 26 and the PTO device 28. The driving force from the continuously variable transmission 26 is transmitted to the PTO device 28 by the clutch as necessary.

Note that the traveling motor 24 is disposed in the front portion of the vehicle body 2 and inside the hood 9. The continuously variable transmission 26 and the PTO device 28 are housed in the transmission case 8b. The driving force of the traveling motor 24 is transmitted to the continuously variable transmission 26 via a transmission shaft or the like.

The driving force of the pump motor 30 is transmitted to the hydraulic pump 32. The hydraulic pump 32 supplies hydraulic oil to the arm cylinder 12 and the bucket cylinder 13 of the front loader 4. The hydraulic oil is lubricating oil stored in the transmission case 8b. Thus, the hydraulic pump 32 is provided in the transmission case 8b. The hydraulic pump 32 is driven by the driving force of the pump motor 30, sucks the hydraulic oil in the transmission case 8b, and pressure-feeds the sucked hydraulic oil to the arm cylinder 12 and the bucket cylinder 13 of the front loader 4.

The inverter 22 supplies electric power from the battery 20 to the traveling motor 24 and the pump motor 30. The inverter 22 includes a drive circuit connected to the traveling motor 24 and a drive circuit connected to the pump motor 30. These drive circuits supply electric power from the battery 20 to the traveling motor 24 and the pump motor 30 on the basis of a torque command value from the processing device 18, and control the traveling motor 24 and the pump motor 30.

The processing device 18 has a function of controlling the traveling motor 24 and the pump motor 30 by providing a torque command value (current command value) to the drive circuit. The processing device 18 performs feedback control so that the traveling motor 24 and the pump motor 30 operate at their target rotation speeds. The processing device 18 is provided with outputs of rotation sensors that detect respective rotation speeds of the traveling motor 24 and the pump motor 30. The processing device 18 obtains the torque command value on the basis of the rotation speed and the target rotation speed of each of the traveling motor 24 and the pump motor 30. The target rotation speed is obtained by the operation control unit 16.

The operation control unit 16 obtains the target rotation speed on the basis of the output provided from the operation lever 5c and provides the target rotation speed to the processing device 18. Therefore, the operation control unit 16 obtains the target rotation speed corresponding to the operation of the work vehicle 1 requested by the worker.

Further, the operation control unit 16 generates information indicating the state of the operation switch 5d on the basis of the output provided from the operation switch 5d, and provides the information to the processing device 18. The information indicating the state of the operation switch 5d includes information indicating that the operation switch 5d is in the on state and information indicating that the operation switch 5d is in the off state.

### Hydraulic System According to First Embodiment

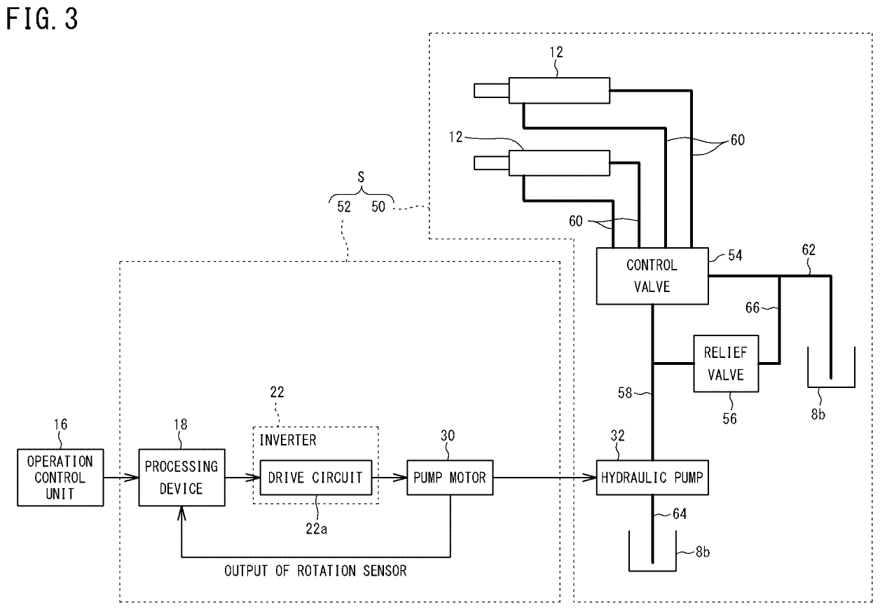

FIG. 3 is a block diagram illustrating an example of a hydraulic system of the work vehicle 1 according to the first embodiment. Note that, in FIG. 3, the bucket cylinder 13 is omitted from the arm cylinder 12 and the bucket cylinder 13 of the front loader 4 for easy understanding.

In FIG. 3, the hydraulic system S includes an oil circulation circuit 50 and a pump control device 52.

The oil circulation circuit 50 is a circuit for circulating the differential oil in the transmission case 8b and supplying and discharging the hydraulic oil to and from the arm cylinder 12. In addition to the hydraulic pump 32, the pair of arm cylinders 12, and the transmission case 8b described above, the oil circulation circuit 50 includes a control valve 54, a relief valve 56, a supply oil passage 58, four supply-discharge oil passages 60, a return oil passage 62, a suction oil passage 64, and the like.

The hydraulic pump 32 sucks the hydraulic oil in the transmission case 8b from the suction oil passage 64 and discharges the hydraulic oil to the supply oil passage 58. The supply oil passage 58 connects the hydraulic pump 32 and the control valve 54. The hydraulic pump 32 pressure-feeds hydraulic oil to the control valve 54 via the supply oil passage 58.

The control valve 54 is connected to the pair of arm cylinders 12 via four supply-discharge oil passages 60. The control valve 54 has a function of performing supply/discharge control of hydraulic oil to/from the pair of arm cylinders 12 on the basis of a command from the operation control unit 16 or the like. The pair of arm cylinders 12 extends and contracts by supply/discharge control of hydraulic oil by the control valve 54. Therefore, the pair of arm cylinders 12 expands and contracts in accordance with an operation input to the operation lever 5c by the worker.

Further, the return oil passage 62 is connected to the control valve 54. The hydraulic oil discharged from the pair of arm cylinders 12 is returned to the transmission case 8b through the control valve 54 and the return oil passage 62.

In this manner, the oil circulation circuit 50 circulates the hydraulic oil in the transmission case 8b.

The relief valve 56 is provided in a bypass oil passage 66. The bypass oil passage 66 connects the supply oil passage 58 and the return oil passage 62. The relief valve 56 closes when a hydraulic pressure value of the hydraulic oil in the supply oil passage 58 is lower than a preset valve opening pressure, thereby closing the bypass oil passage 66. The relief valve 56 opens when the hydraulic pressure value of the hydraulic oil in the supply oil passage 58 is equal to or higher than the valve opening pressure, thereby opening the bypass oil passage 66. Thus, the relief valve 56 sets an upper limit value of the hydraulic pressure value of the supply oil passage 58. That is, the valve opening pressure of the relief valve 56 is the upper limit value of the hydraulic pressure value in the supply oil passage 58.

The pump control device 52 has a function of controlling the pump motor 30 and controlling the operation of the hydraulic pump 32. The pump control device 52 includes the above-described processing device 18, a drive circuit 22a of the inverter 22, a pump motor 30, and the like.

The drive circuit 22a is a drive circuit that controls the pump motor 30 among the drive circuits included in the inverter 22.

The processing device 18 is configured by a computer or the like including a processing unit, a storage unit, and the like.

The processing unit is, for example, various processors adapted to control of a computer, such as a central processing unit (CPU), a graphics processing unit (GPU), a digital signal processor (DSP), and a field programmable gate array (FPGA).

The storage unit includes, for example, a flash memory, a hard disk, a solid state drive (SSD), a read only memory (ROM), and the like.

The storage unit stores a computer program to be executed by the processing unit and necessary information. The processing unit implements various processing functions of the processing device 18 by executing a computer program stored in a computer-readable non-transitory recording medium such as a storage unit.

The target rotation speed and the output of the rotation sensor from the operation control unit 16 are provided to the processing device 18. Further, information indicating the state of the operation switch 5d is provided from the operation control unit 16 to the processing device 18.

The rotation sensor includes, for example, a Hall element included in the pump motor 30, a rotation sensor attached to the pump motor 30 and detecting a rotation speed of the pump motor 30, and the like.

The processing device 18 has a function of obtaining a torque command value to be provided to the drive circuit 22a on the basis of the output of the rotation sensor and the state of the operation switch 5d. The torque command value is a value indicating the torque to be output by the pump motor 30.

The processing device 18 obtains the rotation speed of the pump motor 30 on the basis of the output of the rotation sensor, and performs PID control on the basis of the difference between the target rotation speed and the rotation speed. The processing device 18 obtains a torque command value by calculation based on the PID control.

The processing device 18 controls the pump motor 30 by the torque command value.

### Selection Processing

The processing device 18 has a function of performing selection processing of selecting one of the first mode and the second mode as the control mode of the pump motor 30.

The first mode is a mode in which an upper limit value of the torque command value is a first command value.

The second mode is a mode in which the upper limit value of the torque command value is a second command value larger than the first command value.

The processing device 18 of the present embodiment sets two control modes by changing the upper limit value of the torque command value.

In the first mode, the processing device 18 sets the upper limit value of the torque command value to the first command value. Thus, the processing device 18 limits the current applied to the pump motor 30 and limits the upper limit of the output torque of the pump motor 30 to the torque according to the first command value.

A first hydraulic pressure value generated in the supply oil passage 58 by the hydraulic pump 32 driven by the pump motor 30 operating with the first command value is smaller than the valve opening pressure of the relief valve 56.

Therefore, in the first mode, the processing device 18 operates the pump motor 30 in a range in which the relief valve 56 is not opened.

Note that the first hydraulic pressure value is an upper limit hydraulic pressure value that can be generated in the supply oil passage 58 by the hydraulic pump 32 in a state where there is no load associated with the work operation acting via the arm cylinder 12 and the bucket cylinder 13.

In the second mode, the processing device 18 sets the upper limit value of the torque command value to the second command value. Thus, the processing device 18 limits the current applied to the pump motor 30 and limits the upper limit of the output torque of the pump motor 30 to the torque according to the second command value.

A second hydraulic pressure value generated in the supply oil passage 58 by the hydraulic pump 32 driven by the pump motor 30 operating with the second command value is equal to or more than the valve opening pressure. The upper limit value of the hydraulic pressure of the supply oil passage 58 in the second mode is the valve opening pressure of the relief valve 56.

Therefore, in the second mode, the processing device 18 operates the pump motor 30 in a range in which the relief valve 56 opens.

The second hydraulic pressure value that is the upper limit value of the hydraulic pressure in the second mode is larger than a first hydraulic pressure that is the upper limit value of the hydraulic pressure in the first mode. Thus, the output obtained from the front loader 4 operating in the second mode is higher than the output obtained from the front loader 4 operating in the first mode.

That is, the first mode is a low output mode, and the second mode is a high output mode.

The processing device 18 performs mode selection by selection processing on the basis of the information indicating the state of the operation switch 5d. Thus, the operator can select the control mode of the pump motor 30 as necessary.

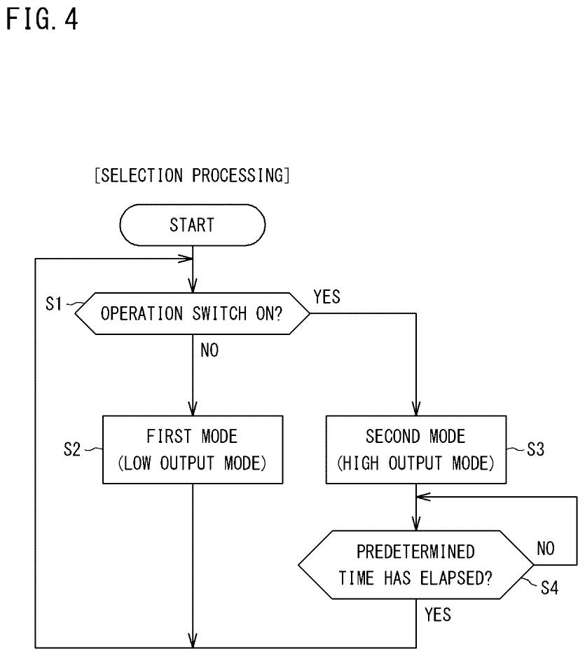

FIG. 4 is a flowchart illustrating an example of selection processing performed by the processing device 18.

First, the processing device 18 determines whether or not the state of the operation switch 5d is the on state (step S1). The processing device 18 refers to the information indicating the state of the operation switch 5d, selects the first mode in a case where the information indicates the off state (step S2), and returns to step S1. In a case where the information indicates the on state, the processing device 18 selects the second mode (step S3) and determines whether or not a predetermined time has elapsed (step S4). The processing device 18 repeats step S4 until a predetermined time elapses.

When the predetermined time has elapsed, the processing device 18 returns to step S1.

If the worker does not press the operation switch 5d, the processing device 18 selects the first mode. That is, the first mode is a normal mode selected when the worker does not perform the operation.

On the other hand, when the worker presses the operation switch 5d, the processing device 18 selects the second mode. The second mode is a temporary mode selected by a worker's operation.

After selecting the second mode, the processing device 18 maintains the second mode for a predetermined time. When the operator releases the hand from the operation switch 5d after the predetermined time, the processing device 18 selects the first mode again.

As described above, in the present embodiment, the second mode in which the upper limit value of the hydraulic pressure is high can be used by the worker as the temporary mode. Thus, in the second mode, the hydraulic pressure can be increased to an allowable extent in the case of use for a short time, and a higher output can be obtained from the front loader 4.

With the above configuration, since the control mode of the pump motor 30 can be selected from the first mode and the second mode in which the upper limit value of the torque command value to the pump motor 30 is different from each other, it is possible to select the first mode in which the upper limit value of the torque command value is low at the normal time and select the second mode in which the upper limit value of the torque command value is higher when higher output is required in the front loader 4. Thus, output higher than normal output can be obtained from the front loader 4 as necessary.

Further, since the work vehicle 1 of the present embodiment includes the traveling motor 24 that generates a hydraulic pressure for causing the work vehicle 1 to travel separately from the pump motor 30 that drives the hydraulic pump 32, even if the control of the pump motor 30 is changed, the traveling of the work vehicle 1 is not affected. Thus, the control mode of the pump motor 30 can be selected from the first mode and the second mode.

### Second Embodiment

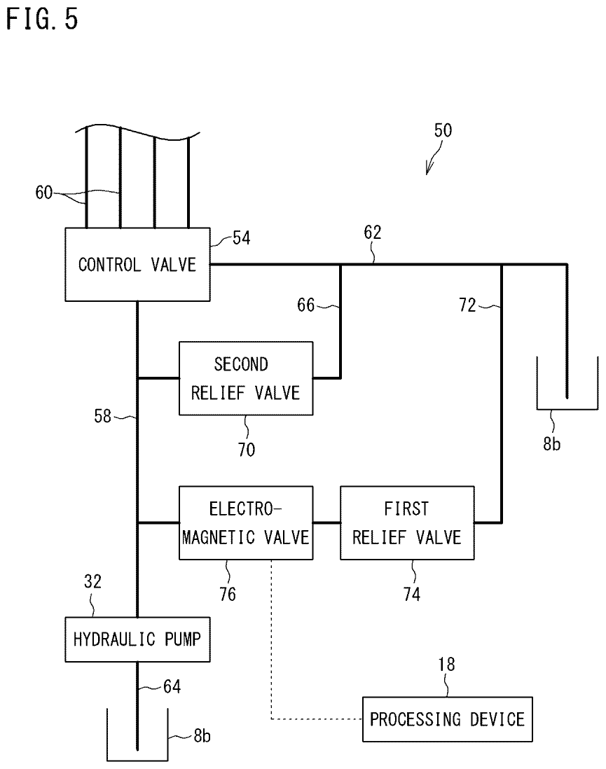

FIG. 5 is a block diagram illustrating a part of a hydraulic system according to a second embodiment.

The oil circulation circuit 50 of the hydraulic system S of the present embodiment is different from the oil circulation circuit 50 of the first embodiment in that two relief valves are provided and an electromagnetic valve is connected in parallel to one relief valve of the two relief valves.

The oil circulation circuit 50 of the present embodiment includes a first relief valve 74, a second relief valve 70, and an electromagnetic valve 76.

The first relief valve 74 is provided in the bypass oil passage 72. The bypass oil passage 72 connects the supply oil passage 58 and the return oil passage 62.

The first relief valve 74 closes when the hydraulic pressure value of the hydraulic oil in the supply oil passage 58 is lower than a preset first valve opening pressure, thereby closing the bypass oil passage 72. The first relief valve 74 opens when the hydraulic pressure value of the hydraulic oil in the supply oil passage 58 is equal to or higher than the first valve opening pressure, thereby opening the bypass oil passage 72.

The second relief valve 70 has the same configuration as the relief valve 56 in the first embodiment. That is, the second relief valve 70 is provided in the bypass oil passage 66. The bypass oil passage 66 connects the supply oil passage 58 and the return oil passage 62.

The second relief valve 70 closes when the hydraulic pressure value of the hydraulic oil in the supply oil passage 58 is lower than a second valve opening pressure set in advance, thereby closing the bypass oil passage 66. The second relief valve 70 opens when the hydraulic pressure value of the hydraulic oil in the supply oil passage 58 is equal to or higher than the second valve opening pressure, thereby opening the bypass oil passage 66.

The second valve opening pressure is higher than the first valve opening pressure.

The electromagnetic valve 76 is provided in a connection oil passage connecting the supply oil passage 58 and the first relief valve 74 in the bypass oil passage 72. The electromagnetic valve 76 opens and closes the connection oil passage. The electromagnetic valve 76 is connected to the processing device 18. The electromagnetic valve 76 opens and closes the connection oil passage on the basis of a command provided from the processing device 18.

The processing device 18 of the present embodiment performs selection processing by opening and closing the electromagnetic valve 76.

In the selection processing of the present embodiment, when the first mode is selected (step S2), the processing device 18 opens the electromagnetic valve 76. Thus, the first relief valve 74 is connected to the supply oil passage 58. Thus, the upper limit value of the hydraulic pressure of the supply oil passage 58 is the first valve opening pressure of the first relief valve 74.

On the other hand, when the second mode is selected in the selection processing (step S3), the processing device 18 closes the electromagnetic valve 76. Thus, the oil passage between the first relief valve 74 and the supply oil passage 58 is disconnected. Thus, the upper limit value of the hydraulic pressure of the supply oil passage 58 is the second valve opening pressure of the second relief valve 70.

The second valve opening pressure that is the upper limit value of the hydraulic pressure in the second mode is larger than the first valve opening pressure that is the upper limit value of the hydraulic pressure in the first mode. Thus, the output obtained from the front loader 4 operating in the second mode is higher than the output obtained from the front loader 4 operating in the first mode.

Here, the first mode is a mode in which the upper limit value of the torque command value is the first command value, and the second mode is a mode in which the upper limit value of the torque command value is the second command value larger than the first command value.

Thus, the first valve opening pressure is a hydraulic pressure value generated in the supply oil passage 58 by the hydraulic pump 32 driven by the pump motor 30 operating with the first command value, and the second valve opening pressure is a hydraulic pressure value generated in the supply oil passage 58 by the hydraulic pump 32 driven by the pump motor 30 operating with the second command value.

In the first mode, since the upper limit value of the hydraulic pressure is the first valve opening pressure, the upper limit value of the torque command value is the first command value.

Further, in the second mode, since the upper limit value of the hydraulic pressure is the second valve opening pressure, the upper limit of the torque command value is the second command value.

Also in the present embodiment, since the control mode of the pump motor 30 can be selected from the first mode which is the low output mode and the second mode which is the high output mode, an output higher than a normal output can be obtained from the front loader 4 as necessary.

### Others

It should be understood that the embodiments disclosed herein are illustrative in all respects and are not restrictive.

For example, in the present embodiment, the case where the working device included in the work vehicle 1 is the front loader 4 has been exemplified, but a backhoe may be used as a working device operated by hydraulic pressure, or both the front loader and the backhoe may be provided.

The scope of the present invention is indicated not by the above meaning but by the claims, and is intended to include meanings equivalent to the claims and all modifications within the scope.

### REFERENCE SIGNS LIST

1 work vehicle
2 vehicle body
3 traveling mechanism
4 front loader
4a frame
4b arm
4c bucket
4d shaft portion
4e shaft portion
5 driving unit
5a steering wheel
5b driver's seat
5c operation lever
5d operation switch
6 front wheel
7 rear wheel
8 chassis
8a frame
8b transmission case
9 hood
10 fender
12 arm cylinder
13 bucket cylinder
16 operation control unit
18 processing device
20 battery
22 inverter
22a drive circuit
24 traveling motor
26 continuously variable transmission
28 PTO device
30 pump motor
32 hydraulic pump
50 oil circulation circuit
52 pump control device
54 control valve
56 relief valve
58 supply oil passage
60 supply-discharge oil passage
62 return oil passage
64 suction oil passage
65 branch oil passage
66 bypass oil passage
70 second relief valve
72 bypass oil passage
74 first relief valve
76 electromagnetic valve
S hydraulic system

1. A hydraulic system comprising:
a hydraulic pump;
a supply oil passage that supplies hydraulic oil from the hydraulic pump to a working device operated by hydraulic pressure;
an electric motor that drives the hydraulic pump; and
a processing device that performs selection processing of selecting a control mode of the electric motor from a first mode and a second mode,
wherein:
the first mode is a mode in which an upper limit value of a torque command value indicating torque to be output by the electric motor is a first command value, and
the second mode is a mode in which the upper limit value is a second command value larger than the first command value.

2. The hydraulic system according to claim 1, further comprising:
an operation switch capable of receiving an operation input of an operator, and
wherein in the selection processing, the control mode is selected on a basis of an output of the operation switch.

3. The hydraulic system according to claim 2, further comprising:
a relief valve that opens when a hydraulic pressure of the supply oil passage reaches a predetermined valve opening pressure, and
wherein a first hydraulic pressure value generated in the supply oil passage by the hydraulic pump driven by the electric motor operating with the first command value is smaller than the valve opening pressure.

4. The hydraulic system according to claim 3, wherein:
a second hydraulic pressure value generated in the supply oil passage by the hydraulic pump driven by the electric motor operating with the second command value is equal to or higher than the valve opening pressure.

5. The hydraulic system according to claim 2, further comprising:
a first relief valve that opens when a hydraulic pressure of the supply oil passage reaches the first valve opening pressure;
an electromagnetic valve that opens and closes a connection oil passage connecting the first relief valve and the supply oil passage; and
a second relief valve that opens when a hydraulic pressure of the supply oil passage reaches a second valve opening pressure higher than the first valve opening pressure,
wherein:
the first valve opening pressure is a hydraulic pressure value generated in the supply oil passage by the hydraulic pump driven by the electric motor operating with the first command value,
the second valve opening pressure is a hydraulic pressure value generated in the supply oil passage by the hydraulic pump driven by the electric motor operating with the second command value, and
the selection processing includes processing of opening and closing the electromagnetic valve.

6. The hydraulic system according to claim 1, wherein:
the processing device performs processing of selecting the control mode again when the second mode is executed for a predetermined period or more.

7. A work vehicle comprising:
a working device; and
the hydraulic system according to claim 1.

8. A control method for an electric motor that drives a hydraulic pump for supplying hydraulic oil to a working device, the method comprising:
selecting a control mode of the electric motor from a first mode and a second mode, wherein:
the first mode is a mode in which an upper limit value of a torque command value indicating torque to be output by the electric motor is a first command value, and
the second mode is a mode in which the upper limit value is a second command value larger than the first command value.

9. A non-transitory computer readable storage medium storing a computer program for causing a computer to execute control of an electric motor that drives a hydraulic pump for supplying hydraulic oil to a working device, the computer program causing the computer to execute:
selection processing of selecting a control mode of the electric motor from a first mode and a second mode,
wherein:
the first mode is a mode in which an upper limit value of a torque command value indicating torque to be output by the electric motor is a first command value, and
the second mode is a mode in which the upper limit value is a second command value larger than the first command value.
